(19) United States
(12) Patent Application Publication
(10) Pub. No.: US 2012/0047498 A1
(43) Pub. Date: Feb. 23, 2012

(54) UPDATING MACHINE-READABLE INSTRUCTIONS IN AN ELECTRONIC DEVICE

(76) Inventors: Giovanni Motta, San Diego, CA (US); Marko Slyz, San Diego, CA (US); Sait Can Saydag, San Diego, CA (US)

(21) Appl. No.: 12/858,533

(22) Filed: Aug. 18, 2010

(51) Int. Cl. G06F 9/44

(52) U.S. Cl. 717/171

(57) ABSTRACT

To update machine-readable instructions in an electronic device, update information for updating the machine-readable instructions of the electronic device is determined based on reducing an update time that accounts for a communication link speed and an application time for applying the update information, where the application time is dependent upon information relating to the components of the electronic device.

### BACKGROUND

An electronic device typically employs machine-readable instructions to perform various predefined tasks. The machine-readable instructions can include software instructions (e.g., application software instructions, operating system instructions, etc.) and/or firmware instructions (e.g., Basic Input/Output System or BIOS firmware instructions, etc.). In certain types of devices, such as mobile devices or embedded devices, firmware instructions can be implemented in software. Occasionally, due to an error or other fault associated with the machine-readable instructions or due to availability of a newer version of the machine-readable instructions, update information can be provided to the electronic device to update the machine-readable instructions.

### BRIEF DESCRIPTION OF THE DRAWINGS

Some embodiments are described with respect to the following figures:

FIG. 1 is a block diagram of an example arrangement that incorporates some embodiments; and

FIGS. 2 and 3 are flow diagrams of processes for updating machine-readable instructions in an electronic device, according to some embodiments.

### DETAILED DESCRIPTION

The machine-readable instructions of an electronic device (e.g., a computer, personal digital assistant, mobile telephone, electronic appliance, etc.) can be updated for various reasons. For example, if execution of the machine-readable instructions produces an error or other fault, then the machine-readable instructions should be updated to resolve the error or other fault condition. Alternatively, a newer version of the machine-readable instructions can be available, and the machine-readable instructions can be upgraded to the newer version to provide enhanced or additional features. Examples of machine-readable instructions executable in an electronic device include software instructions and/or firmware instructions.

Traditionally, for an electronic device that communicates primarily over a wireless link, it is desirable to reduce the size of the update information used for updating machine-readable instructions to reduce communication delay associated with communicating the update information over the wireless link to the electronic device. This traditional approach is based on the assumption that the wireless link is relatively slow and unreliable, that usage of such wireless link can be relatively expensive to a user, or that a download server is kept busy for the duration of the communication. To reduce the size of the update information, compression and/or other processing can be applied to the update information so that the size of the update information is reduced or minimized.

However, with the advent of improved wireless technologies, the communication speeds of wireless links have improved. Examples of wireless technologies that provide increased communication speeds include wireless local area network technologies (e.g., WiFi technology as defined by IEEE 802.11), third generation (3G) mobile telecommunications technologies, fourth generation (4G) mobile telecommunications technologies, and so forth. With availability of relatively high-speed wireless links, the amount of time involved in downloading update information to an electronic device over a wireless link can be reduced substantially.

Although compression or application of other processing to update information can reduce the size of the update information, the applied processing (e.g., compression) can lead to increased workload at the electronic device when the electronic device applies the update information, which results in increased processing time at the electronic device when applying the update information. For example, decompressing update information at the electronic device can take some amount of time. Other processing tasks that may have to be performed by the electronic device to apply update information can include calculating check codes (e.g., cyclic redundancy check or CRC codes, checksums, signatures, etc.), preprocessing executable code in the update information, or other tasks, which can also lead to increased application time for the update information. Examples of preprocessing executable code include transforming the executable code from a first version to a different version, such as by changing pointers, references, and/or other structures in the executable code.

Thus, the goal of minimizing the size of update information can result in increased processing time at the electronic device when attempting to apply the update information at the electronic device. The increased application time can exceed any time savings achieved in reduced communication time due to communicating smaller update information. Also, the communication to the electronic device may occur while the electronic device is still online and usable, so in that sense the time used for communication may be less important than the time spent applying the update, when the electronic device may be offline and unusable.

In accordance with some embodiments, generation of update information to update machine-readable instructions of an electronic device takes into account total update time involved in performing the update. The total update time includes at least a communication time (associated with communication of the update information over a communication link) and an application time (associated with applying the update information at the electronic device). The “communication link” over which the update information is communicated can be a wireless link, a wired link, or a combination of both wireless and wired links.

In some implementations, an objective is to reduce or minimize the total update time (which is an aggregate of at least the communication time and the application time). The “aggregate” of the communication time and the application time can refer to some mathematical combination of the communication time and application time, such as a sum or weighted sum of the communication time and application time. Other aggregates of the communication time and application time can be applied in other implementations.

According to some implementations, the total update time is calculated as follows:

$$Total Update Time = Communication Speed * UP Size + UP Application Time , \qquad ( Eq . 1 )$$

where Communication Speed represents a speed of communicating data over the communications link, UP Size represents the size of the update information and UP Application Time represents the time involved in applying the update information.

Generally, the update information includes metadata describing an update, and executable instructions that when executed at the electronic device perform operations (e.g., conversion or translation operations) to update at least a portion of existing machine-readable instructions. In some examples, the update information can also be referred to as an update package, which refers to an assembly of items (e.g., metadata, executable instructions, etc.) that can be processed to apply the specified update.

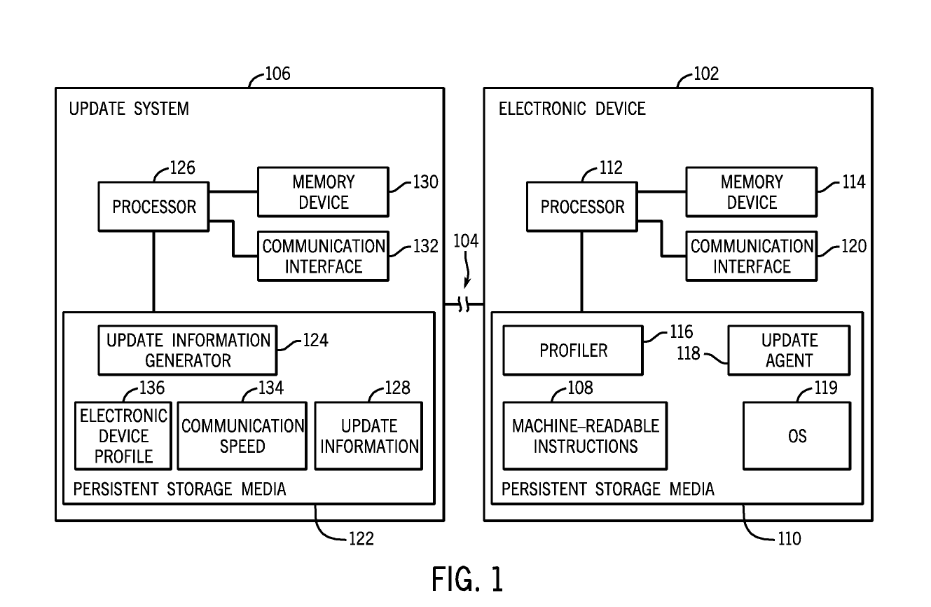

FIG. 1 illustrates an example arrangement that includes an electronic device 102 that is coupled over a communication link 104 to an update system 106. Although the update system 106 is depicted as being in a singular box, it is noted that the update system 106 can actually be distributed across multiple computer nodes. Also, although just one electronic device 102 is depicted in FIG. 1, it is noted that there can be multiple electronic devices that can use services provided by the update system 106 to update machine-readable instructions in the respective electronic devices.

The electronic device 102 includes updateable machine-readable instructions 108, which can be stored in persistent storage media 110. “Persistent” storage media refers to storage media that maintains its content even when power is removed from the electronic device 102. Examples of persistent storage media include a non-volatile memory device such as a flash memory device, or a disk-based storage device (e.g., a magnetic disk-based storage device or optical disk-based storage device). The persistent storage media 110 of FIG. 1 can represent any one or combination of the foregoing storage media.

The electronic device 102 also includes a processor 112 coupled to the storage media 110, and to a memory device 114 (which can be a volatile memory device such as a memory device implemented using random access memory technology, such as dynamic random access memory technology or static random access memory technology). The memory device 114 can represent the main memory of the electronic device 102, or alternatively or additionally, the memory device 114 can represent cache memory used in the electronic device 102.

A profiler 116 and an update agent 118 are also stored in the persistent storage media 110. The profiler 116 is executable on the processor 112 to collect information regarding components of the electronic device 102. The update agent 118 is executable on the processor 112 to apply update information received by the electronic device 102 to update the machine-readable instructions 108. An operating system 119 for the electronic device 102 is also stored in the persistent storage media 110.

The electronic device 102 also includes a communication interface 120 to allow the electronic device 102 to communicate over the communication link 104. The communication link 104 that couples the electronic device 102 to the update system 106 can be a wired link, a wireless link, or a combination of wired and wireless links.

The update system 106 includes persistent storage media 122 (similar to persistent storage media 110 in the electronic device 102). An update information generator 124 is stored in the persistent storage media 122, and the update information generator 124 is executable on a processor 126 in the update system 106 to perform generation of update information 128 for provision to the electronic device 102 over the communication link 104. The generated update information 128 can also be stored in the persistent storage media 122.

The update system 106 also includes a memory device 130 (similar to the memory device 114 of the electronic device 102) and a communication interface 132 coupled to the processor 126 to allow the update system 106 to communicate over the communication link 104.

The update system 106 stores information 134 relating to the communication speed (of the communication link 104) in the persistent storage media 122. The communication speed of the communication link 104 can be determined based on communicating test packets between the update system 106 and electronic device 102. The test packets can be transmitted by either the update system 106 or the electronic device 102, or both.

Also, an electronic device profile 136 is stored in the persistent storage media 122, where the electronic device profile 136 includes information relating to components of the electronic device 102 collected by the profiler 116 in the electronic device 102.

The electronic device profile 136 and the information relating to communication speed 134 are provided as inputs to the update information generator 124, which is able to vary the content of the update information 128 based on the objective of reducing or minimizing the total update time. The information relating to the communication speed 134 allows the update information generator 124 to determine a communication time for communicating the update information 128 over the communication link 104, given a particular content of the update information 128.

The electronic device profile 136 allows the update information generator 124 to estimate an application time for applying the update information 128 at the electronic device 102, given a particular content of the update information 128.

The content of the update information 128 produced by the update information generator 124 is dependent upon the objective of reducing the total update time that is based on aggregating at least a communication time and an application time, as discussed above. For example, if the communication link 104 is a relatively slow link (has a relatively low communication speed), then the update information generator 124 can produce a smaller size update information 128, such as by compressing the update information 128. Note that compressing the update information 128 means that the electronic device 102 would have to decompress the update information 128, which would increase the application time at the electronic device 102.

In contrast, if the communication link 104 has a relatively high communication speed, then a larger size update information 128 can be provided—the larger update information 128 may allow for reduced application time at the electronic device 102. For example, if a higher speed communication link is detected, the update information generator 124 can avoid compressing the update information 128, such that the update information 128 can remain uncompressed when sending to the electronic device 102. At the electronic device 102, the uncompressed update information 128 can be processed more quickly since the electronic device 102 would not have to apply decompression.

The update information 128 produced by the update system 106 can specify an update to fix an error or other fault in the machine-readable instructions 108 at the electronic device 102, or to upgrade the machine-readable instructions 108 from a first version to a second, newer version.

The electronic device profile 136 can include one or a combination of the following: information relating to hardware components of the electronic device; information relating to performance of predetermined operations associated with updating the machine-readable instructions 108; and information relating to a platform of the electronic device.

The information relating to hardware components can include information relating to features of hardware components, such as one or a combination of the following: the operating speed of the processor 112, a cache architecture used in the electronic device 102 (e.g., the number of cache levels and the size of each cache level), the type of flash memory (e.g., NAND-type flash memory or NOR-type flash memory) used and associated access speeds (including speeds to perform an erase operation, a read operation, and a write operation), an access speed of random access memory, available size of flash memory or random access memory that can be used as temporary storage during updating of the machine-readable instructions 108, the amount of free memory space in the user area of the memory device 114, a current power state of the electronic device (e.g., whether the electronic device 102 is running on battery, being recharged, or cradled in a docking station), the amount of charge left on a battery if the electronic device 102 is being run on battery, the connection type (type of the communication link 104) and associated speed, and information regarding other resources that may be used during an update operation for updating the machine-readable instructions 108.

Higher operating speeds for the processor and greater availability of memory, including cache memory, random access memory, and/or flash memory, means that the electronic device 102 can perform more operations at faster speeds. The power state of the electronic device 102 can impact how much processing should be performed by the electronic device 102 when performing updating of the machine-readable instructions 108. For example, if the electronic device 102 is being run on battery or if the battery has a relatively low level, then it would be desirable to minimize the processing performed by the electronic device 102 to update the machine-readable instructions 108, to avoid depleting the battery.

The information relating to performance of predetermined operations associated with updating the machine-readable instructions 108 can include a time involved in computing a check code (e.g., CRC code, checksum, or signature) of a block of the update information, a time to decompress and/or re-compress a particular block of the update information 128, a time to preprocess executable code in the update information, algorithms used during the update operation, and so forth. If the time associated with computing the check code, performing decompression or re-compression, or performing preprocessing, is relatively large, then the update information generator 124 would produce update information 128 that avoids or reduces performance of the corresponding one or combination of the foregoing operations. For example, the update information 128 can remain uncompressed such that decompression does not have to be performed by the electronic device 102. Alternatively, keeping the update information compressed may speed up the CRC computation for the update information if that computation is done on the update information in its compressed form. Also, it may be possible to arrange the update system 106 to avoid using certain blocks in the machine-readable instructions 108 as source material for differential update (where the update is performed by copying data from the certain blocks already in the electronic device). If such blocks do not have to be verified using CRC to determine whether they contain the original version of the machine-readable instructions 108, then it may be possible to skip CRC calculation for such blocks. Note that since data from the certain blocks is not available, that data may have to be included in the update information 128, which would increase its size—however, application time is reduced since CRC computation does not have to be performed.

In some scenarios, if the communication speed of the communication link 104 is high enough, it may be faster to send the entire updated machine-readable instructions to replace the existing machine-readable instructions 108, rather than just the difference information that specifies the difference between the existing machine-readable instructions 108 and the updated machine-readable instructions. Thus, in such examples, the update information 128 would include the entire updated machine-readable instructions.

More generally, the update information generator 124 can use the information relating to performance of predetermined operations to identify certain functions (e.g., decompression functions, CRC calculation functions, preprocessing functions, etc.) associated with updating the machine-readable instructions 108 that take up certain respective amounts of processing time when applying update information containing such functions at the electronic device 102. The update information generator 124 can decide to include or omit selected content in the update information 128 that would invoke or avoid invocation of such functions based on the objective of reducing or minimizing the total update time.

The information relating to the platform of the electronic device can include information relating to overhead of an operating system in the electronic device 102 associated with reading or writing files, whether the electronic device 102 is able to support multitasking, and information relating to system calls that are used during the update of the machine-readable instructions 108. The foregoing information relating to the platform can be used by the update information generator 124 to estimate the application time associated with applying the update information 128 of a particular content.

If the electronic device 102 is able to support multitasking, then certain operations associated with updating the machine-readable instructions 108 can be performed as a background operation while a user is actively engaged in another activity at the electronic device 102. For example, operations that can be performed in the background include decompressing the update information 128, preprocessing executable code in the update information 128, or calculating CRCs for blocks of the update information 128. In such implementations, the total update time would be based on aggregating the communication time, application time, and background operation time (time for performing the background operation), as indicated below in Eq. 2:

Total Update Time=Communication Speed*UP Size+UP Application Time+Background Operation Time. (Eq. 2)

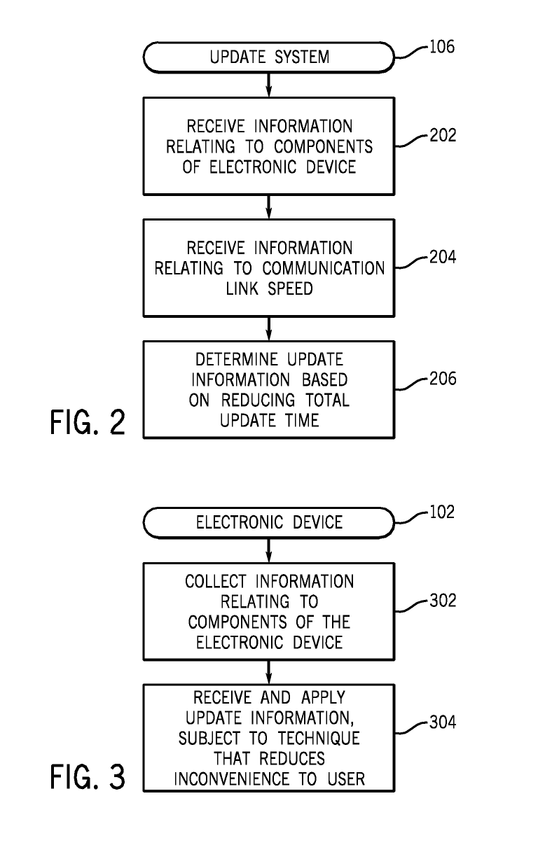

FIG. 2 is a flow diagram of a process that can be performed by the update system 106, according to some implementations. The process of FIG. 2 can be performed by the update information generator 124, for example.

The update system 106 receives (at 202) profile information relating to components of the electronic device 102. This profile information relating to the components of the electronic device can be in the form of the electronic device profile 136 depicted in FIG. 1.

The update system 106 also receives (at 204) information relating to the communication speed of the communication link 104 that is connected to the electronic device 102.

The update system 106 then determines (at 206) update information for updating the machine-readable instructions 108 shown in FIG. 1 of the electronic device, where the determined update information is based on reducing the total update time that accounts for the communication speed and the application time for applying the update information at the electronic device 102. As noted above, the application time can be determined based on the electronic device profile 136 (FIG. 1). In some implementations, reducing or minimizing the total update time is according to Eq. 1 or 2.

Note that the receipt of the profile information (202) relating to the components of the electronic device can be performed on a continual basis, or can be performed just once at initial setup of the electronic device 102. Note also that the profile information can be collected upon integration of the update agent 118 (FIG. 1) into the electronic device 102 prior to deployment of the electronic device 102 in the field. Alternatively, the profile information can be collected after the electronic device 102 has been deployed in the field for use by a user.

The communication link speed information (received at 204) can be collected on a continual or intermittent basis. Note that the communication link speed can change over time as usage of the communication link 104 (FIG. 1) changes.

FIG. 3 is a flow diagram of a process performed by the electronic device 102, according to some implementations. The profiler 116 (FIG. 1) of the electronic device 102 collects (at 302) information relating to the components of the electronic device 102, where the profiler 116 after collecting the information causes the collected information to be sent to the update system 106, such as in the form of the electronic device profile 136 shown in FIG. 1.

The update agent 118 of the electronic device 102 is able to receive (at 304) the update information 128 (FIG. 1) from the update system 106, and to apply such update information. As depicted in FIG. 3, the application of the update information can be based on implementation of a technique to reduce user inconvenience associated with updating the machine-readable instructions 108. If the user is actively using the electronic device 102, it may be undesirable to perform the updating since such updating may slow down the activities in which the user is actively engaged. Note also that the updating may prevent those activities entirely if the electronic device has to go offline to do the update, which is often the case.

The technique to reduce user inconvenience (implemented at 304) is able to determine a time at which the update of the machine-readable instructions is to be initiated. The determined initiate time can be based on a location of the electronic device 102. If the electronic device 102 is at a location where the user is likely to have an alternate electronic device available (such as when the user is at the office or at home), then the determined initiate time would be the time at which the update agent 118 detects that the electronic device 102 is in such a location. The present location of the electronic device 102 can be based on GPS (global positioning system) coordinates received by the electronic device 102, which can be provided with a GPS receiver (not shown).

Alternatively, the update agent 118 can determine, based on the current workload and usage history of the electronic device 102, a time interval during which usage of the electronic device 102 is expected to be low. This can be during evening hours or late at night or at any other time interval during which activity at the electronic device 102 is expected to be low.

It is noted that a user may not be available to confirm performance of an update if the update is initiated at a time when the user is likely asleep or otherwise unavailable. Thus, the update agent 118 can consider availability of a user to confirm an update operation in determining the time at which the update operation is to be initiated.

By using techniques or mechanisms according to some implementations, user experience for updating machine-readable instructions of an electronic device is enhanced, in terms of reduced total update time and/or reduced intrusion by the update operation.

Instructions of modules described above (including the profiler 116, update agent 118, and update information generator 124 of FIG. 1) are loaded for execution on a processor (such as processor 112 or 126 in FIG. 1). A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method of updating machine-readable instructions in an electronic device, comprising:
receiving, by a system having a processor, information relating to components of the electronic device;
receiving, by the system, communication link speed information regarding a speed of communicating data over a link to the electronic device; and
determining, by the system, update information for updating the machine-readable instructions of the electronic device, wherein determining the update information is based on reducing an update time that accounts for the communication link speed and an application time for applying the update information, wherein the application time is dependent upon the information relating to the components of the electronic device.

2. The method of claim 1, further comprising calculating the update time that includes a communication time and the application time, wherein the communication time is based on the communication link speed and a size of the update information.

3. The method of claim 2, wherein determining the update information comprises:
adjusting content of the update information based on the communication link speed and the corresponding application time.

4. The method of claim 1, wherein receiving the information relating to the components comprises receiving information relating to hardware components in the electronic device.

5. The method of claim 1, wherein receiving the information relating to the components comprises receiving information selected from among times associated with predetermined operations, an algorithm used for performing an update of the machine-readable instructions, overhead of an operating system to access data, an ability to perform multitasking, and types of system calls used during an update of the machine-readable instructions.

6. The method of claim 1, further comprising:
determining at least one task associated with updating the machine-readable instructions that can be performed as a background process of the electronic device, wherein determining the update information for updating the machine-readable instructions is based on reducing the update time that accounts for the communication link speed, the application time, and a time associated with the background process.

7. The method of claim 1, wherein determining the update information based on reducing the update time comprises determining the update information based on minimizing the update time.

8. The method of claim 1, further comprising:
sending the update information to the electronic device to cause the update of the machine-readable instructions at the electronic device.

9. An electronic device comprising:
a processor;
a communication interface to a communication link;
machine-readable instructions executable on the processor that are updateable;
a profiler executable on the processor to collect information regarding components of the electronic device, wherein the profiler is to cause the collected information to be sent to an update system to generate update information for updating the machine-readable instructions, wherein content of the update information generated by the update system is dependent upon reducing an update time that is based on aggregating a communication time and an application time, wherein the communication time is based on a speed of the communication link, and the application time is a time for applying the update information that is based on the collected information; and
an update agent executable on the processor to receive the update information having content generated by the update system that is dependent upon reducing the update time.

10. The electronic device of claim 9, wherein the collected information comprises at least one selected from among: information relating to features of hardware components in the electronic device, information relating to performing predetermined operations associated with updating the machine-readable instructions, and information relating to a platform of the electronic device.

11. The electronic device of claim 9, wherein the content of the update information is adjusted to reduce the application time if the communication link has a higher communication speed.

12. The electronic device of claim 11, wherein the content of the update information is adjusted to allow for avoiding at least one selected from among:
performing decompression of a portion of the update information at the electronic device, calculating a check code based on the update information, and preprocessing executable code in the update information.

13. The electronic device of claim 9, wherein the updateable machine-readable instructions include software instructions or firmware instructions.

14. The electronic device of claim 9, wherein the update agent is executable to further:
determine a time to initiate application of the update information.

15. The electronic device of claim 14, wherein determining the time to initiate application of the update information is based on a present location of the electronic device.

16. The electronic device of claim 14, wherein determining the time to initiate application of the update information is based on an analysis of usage information of the electronic device to predict a time interval during which usage of the electronic device is expected to be reduced.

17. An article comprising machine-readable storage media storing instructions that upon execution cause a system having a processor to:
receive profile information relating to components of the electronic device;
receive communication link speed information regarding a speed of communicating data over a link to the electronic device; and
determine update information for updating machine-readable instructions at the electronic device, wherein determining the update information is based on reducing an update time that accounts for the communication link speed and an application time for applying the update information, wherein the application time is estimated based on the profile information.

18. The article of claim 17, wherein a function associated with updating the machine-readable instructions at the electronic device can be performed as a background operation in the electronic device, and wherein determining the update information is based on reducing the update time that accounts for the communication link speed, the application time for applying the update information, and a time for performing the background operation.

19. The article of claim 17, wherein the profile information comprises at least one selected from among: information relating to features of hardware components in the electronic device, information relating to performing operations associated with updating the machine-readable instructions, and information relating to a platform of the electronic device.
